(19) United States
(12) Patent Application Publication
(10) Pub. No.: US 2017/0348602 A1
(43) Pub. Date: Dec. 7, 2017

(54) MULTIPLE COMPONENT TRANSITION TOY ASSEMBLY

(71) Applicant: Laura Hoinsky, Mystic, CT (US)

(72) Inventor: Laura Hoinsky, Mystic, CT (US)

(21) Appl. No.: 15/175,207

(22) Filed: Jun. 7, 2016

(51) Int. Cl. A63H 3/02; G06K 7/10; A63H 3/00; A63H 33/26; G08B 21/18; G08B 5/36

(52) U.S. Cl. CPC A63H 3/02; G08B 21/182; G08B 5/36; A63H 3/006; A63H 33/26; G06K 7/10386

(57) ABSTRACT

A multiple component transition toy assembly for easing a child user's transition between various locations includes a portable component formed from a plush, stuffed body having an attachment member and a destination component formed from a rigid body having a retaining member. The portable component can be selectively coupled with the destination component because the attachment member is operative to form a releasable attachment with the retaining member. The portable component may be weighted to provide a grounding feeling to a child user. The transition toy assembly may include a wirelessly actuated sensory output device which causes the destination component to acknowledge the presence of the portable component through a sensory output.

### BACKGROUND OF THE INVENTION

### Field of the Invention

This invention relates generally to amusement devices and, more particularly, to a toy assembly for emotional support having two discrete components which are removably attachable and which each have different textures.

### Description of the Prior Art

It is well known that some young children often experience difficulties in transitioning from one place to another. For such children, the stress brought on from such transitions can lead to other negative behaviors, such as tantrum throwing and defiance of authority figures. Thus, there remains a need for a transition toy assembly which operates to absorb the attention of a child during a transition so as to reduce or eliminate the negative behaviors which may result therefrom. It would be helpful if such a transition toy assembly included a plush portable component and a rigid destination component which were constructed to be selectively attachable. It would be additionally desirable for the components of such a transition toy assembly to include an electronic coupling recognition system which generate a sensory response through the connection of the portable component and destination component.

The Applicant's invention described herein provides for a transition toy assembly adapted to absorb the attention of a child during a transition between places. The primary components in Applicant's transition toy assembly are a portable component and a destination component. When in operation, the transition toy assembly operates to reduce the negative behaviors which often accompany transitions between places for some youth As a result, problems not solved by prior art structures are able to be addressed.

### SUMMARY OF THE INVENTION

A multiple component transition toy assembly for easing a child user's transition between various locations. The transition toy assembly comprises a portable component defining a plush, stuffed body having an attachment member and a destination component defining a rigid body having a retaining member which is operative to form a releasable attachment with the attachment member, thereby enabling the portable component to be selectively coupled with the destination component. In one embodiment, the portable component is weighted to provide a grounding feeling to a child user. In one embodiment, the transition toy assembly may include a wirelessly actuated sensory output device which causes the destination component to acknowledge the presence of the portable component through a sensory output.

It is an object of this invention to provide a need for a transition toy assembly which operates to absorb the attention of a child during a transition so as to reduce or eliminate the negative behaviors which may result therefrom.

It is another object of this invention to provide a transition toy assembly which includes a plush portable component and a rigid destination component which were constructed to be selectively attachable.

It is yet another object of this invention to provide a transition toy assembly which includes an electronic coupling system which generates a sensory response through the connection of the portable component and destination component.

These and other objects will be apparent to one of skill in the art.

### BRIEF DESCRIPTION OF THE DRAWINGS

FIG. 1 is a side perspective view of a portable component of a transition toy assembly built in accordance with the present invention.

FIG. 2 is a side perspective view of a destination component of a transition toy assembly built in accordance with the present invention.

### DETAILED DESCRIPTION OF THE INVENTION

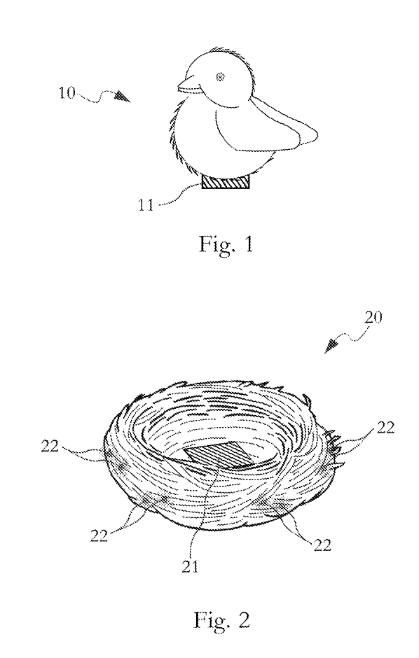

Referring now to the drawings and in particular FIG. 1, a portable component 10 of a transition toy assembly defines a stuffed body having plush, soft exterior and an attachment member 11 integral therewith. In the illustrated embodiment, the portable component 10 is shown having the appearance of a toy bird. It is contemplated, however, that in alternate embodiments, the portable component 10 may define an alternate toy character, such as a pirate, fireman, princess, puppy and so forth.

In one embodiment, the portable component 10 is weighted to provide a grounding feeling to a child user. In such an embodiment, the portable component 10 includes a weighted stuffing material (not shown), such as dry beans or other solid particulate, to increase its weight and provide a more.

Referring now to FIG. 2, a destination component 20 of a transition toy assembly defines a rigid body having a retaining member 21 integral therewith. In one embodiment, the form of the destination component 20 is complementary to the toy character which defines the portable component which accompanies the destination component. In this regard, in the illustrated embodiment the destination component 20 is shown having the appearance of a bird nest, which complements the illustrated toy bird portable component. Along the same lines, if the portable component had the appearance of a pirate, it is contemplated that the destination component 20 may have the appearance of a ship. And if the portable component had the appearance of a princess, it is contemplated that the destination component 20 may have the appearance of a castle.

Referring now to FIGS. 1 and 2, it is contemplated that the portable component 10 and destination component 20 are removably attachable to one another through the attachment member 11 and retaining member 21, respectively. In one embodiment, the attachment member 11 defines a ferromagnetic material and the retaining member 21 defines a permanent magnet. In another embodiment, the attachment member 11 may define a loop aspect of a fabric hook and loop fastener and the retaining member 21 may define a hook aspect of a fabric hook and loop fastener.

In addition, in one embodiment, the portable component 10 and destination component 20 include internal electrical components which enable the destination component 20 to recognize and acknowledge the presence of an associated portable component 10. For example, the portable component 10 may include a passive RFID tag and the destination component 20 includes an RFID reader, a battery, a controller and a sensory output device. In such an embodiment, the sensory output device may define a plurality of LED lighting elements 22 and when the portable component 10 is within a predefined proximity (3 feet in one embodiment) of the destination component 20, the RFID reader will receive a backscatter signal from the portable component 10 which signals to the controller to cause the LED lighting elements 22 to illuminate. It is contemplated that such illumination may desirably be a single flash (for each backscatter signal received) in order to reduce power consumption.

In one embodiment, a single portable component 10 may be associated (by way of having a complementary attachment member 11 and retaining member 21 and a compatible RFID tag for the RFID readers) with a plurality of identical but discrete destination components 20 so that a destination component 20 can be left in various locations a child user may frequent.

The instant invention has been shown and described herein in what is considered to be the most practical and preferred embodiment. It is recognized, however, that departures may be made therefrom within the scope of the invention and that obvious modifications will occur to a person skilled in the art.

1. (canceled).

2. (canceled).

3. (canceled).

4. (canceled).

5. (canceled).

6. (canceled).

7. A multiple component transition toy assembly, comprising:
a portable component defining a plush, stuffed body having an attachment member integral therewith, wherein said portable component is stuffed with a solid particulate;
a destination component defining a rigid body having a retaining member integral therewith, wherein said attachment member is adapted to form a releasable attachment with the retaining member so as to enable the portable component to be selectively coupled with the destination component;
an electronic coupling recognition system integral with said portable component and destination component, wherein said electronic coupling recognition system causes at least one of the portable component and destination component to generate a sensory output while the portable component and destination component are within a predetermined proximity of one another.

8. The multiple component transition toy assembly of claim 1, wherein said attachment member defines at least one of a ferromagnetic material and a permanent magnet.

9. The multiple component transition toy assembly of claim 8, wherein said retaining member defines at least one of a ferromagnetic material and a permanent magnet.

10. The multiple component transition toy assembly of claim 7, wherein said attachment member defines at least one of a loop aspect of a hook and loop fastener and a hook aspect of a hook and loop fastener.

11. The multiple component transition toy assembly of claim 10, wherein said retaining member defines at least one of a loop aspect of a hook and loop fastener and a hook aspect of a hook and loop fastener.

12. The multiple component transition toy assembly of claim 7, wherein said portable component is stuffed with a solid particulate.

13. The multiple component transition toy assembly of claim 7, wherein said electronic coupling recognition system causes the destination component to generate the sensory output while the portable component and destination component are within a predetermined proximity of one another.

14. The multiple component transition toy assembly of claim 13, wherein said electronic coupling recognition system includes a passive RFID tag integral with said portable component and a RFID reader integral with said destination componenet.

15. The multiple component transition toy assembly of claim 13, wherein said sensory output defines the illumination of at least one lighting element.
